(19) United States
(12) Patent Application Publication
(10) Pub. No.: US 2011/0205731 A1
(43) Pub. Date: Aug. 25, 2011

(54) Identification Device

(75) Inventors: Eoin Seirorse O'Keefe, Gosport (GB); Adam Joseph Shohet, Guildord (GB); Martin Swan, Aldershot (GB)

(73) Assignee: QINETIQ LIMITED, London (GB)

(21) Appl. No.: 12/955,568

(22) Filed: Nov. 29, 2010

(30) Foreign Application Priority Data
Nov. 30, 2009 (GB) 0920911.5
Feb. 15, 2010 (GB) 1002494.1

(51) Int. Cl. F21L 4/00; F21V 21/00; F21V 33/00

(52) U.S. Cl. 362/190; 362/382; 250/522.1

(57) ABSTRACT

The invention relates generally to an electro-optic identification device, particularly to a helmet-mounted identification device. An identification device suitable for mounting on an object comprises a support structure having a plurality of electro-optic emitters positioned thereon, wherein the support structure conforms, in use, to the shape of said object. Preferably, the support structure takes the form of a plurality of emitter arms radiating from a hub, each arm comprising one or more electro-optic emitters. The electro-optic emitters may include visible emitters and/or infrared emitters, and are more preferably selected from the group consisting of near infrared emitters, medium wave thermal infrared emitters and long wave thermal infrared emitters, or any combination thereof. The invention has particular utility in military applications.

### FIELD OF THE INVENTION

This invention relates generally to an electro-optic identification device, particularly an identification device emitting radiation in the electro-optic spectrum between 180 nm and 20,000 nm, more particularly to an identification device emitting radiation in the ultraviolet, visible, near infrared and/or thermal infrared wavelength ranges, and even more particularly to an identification device emitting radiation in the near infrared and/or thermal infrared wavelength ranges. The invention also relates to a helmet comprising the invention and a related identification method.

### BACKGROUND OF THE INVENTION

Identification devices are known which emit radiation in any or all of the visible, near infrared and/or thermal infrared parts of the electro-optic spectrum, optionally as regular or intermittent flashes. The near infrared and/or thermal infrared radiation emitted from the identification device can be viewed through a range of imaging devices such as, for example, imaging devices based on image intensifiers (e.g. night vision goggles—or NVGs—and image intensifier weapon sights) and imaging devices based on thermal imaging systems (e.g. thermal cameras, forward looking infrared (FLIR) and thermal weapons sights). In military scenarios, it is possible to use an infrared emitting device of this type in conjunction with a sensor operating in the corresponding waveband to uniquely identify marked objects and hence, discriminate these from other objects on the battlefield in an effort to avoid friendly fire incidents.

Electro-optic identification devices—which can also be known as visible, near infrared or thermal infrared beacons—can be used in a variety of different applications, but are generally three dimensional, solid, discrete devices mounted on vehicles and structures, a typical embodiment being a hemispherical dome. For some applications, however, it is desirable to have a portable electro-optic beacon and even more desirable to have an electro-optic beacon capable of being personnel mounted. Usually, a near infrared beacon includes devices that emit at around 800 nm to 950 nm and can be detected using image intensifier based devices, and a thermal infrared beacon includes emitting devices that emit in the range 3,000 nm to 5,000 nm and/or 8,000 nm to 12,000 nm so that the beacon is visible using thermal imaging devices operating in these wavebands.

### SUMMARY OF THE INVENTION

According to a first aspect of the invention, there is provided an identification device suitable for mounting on an object, said device comprising a support structure having a plurality of electro-optic emitters positioned thereon, wherein the support structure conforms, in use, to the shape of said object. The object may be any object, but is preferably a part or section of a vehicle, structure or person, and is more preferably a prominent part or section which is easily visible from the ground and/or air. Object includes part of an object, such as, for example, the top portion of a helmet.

The invention has particular—although not exclusive—application to personnel identification devices, and especially to helmet mounted devices.

By electro-optic emitter is meant a source of electromagnetic radiation, said radiation including—but not being limited to—ultraviolet radiation, visible light, near infrared radiation and/or thermal infrared radiation. By ultraviolet radiation is generally meant the wavelength range 180 nm to 380 nm, by visible light is generally meant the wavelength range 380 nm to 700 nm, by near infrared is generally meant the wavelength range 700 nm to 1,400 nm, and the term thermal infrared radiation generally encompasses short wave thermal infrared wavelengths (1,400 nm to 3,000 nm), medium wave thermal infrared wavelengths (3,000 nm to 8,000 nm) and long wave thermal infrared wavelengths (8,000 nm to 15,000 nm). The afore-mentioned wavelength range definitions are for guidance only, and are not intended to be strictly limiting.

Accordingly, examples of electro-optic emitters that can be used in the identification device include ultraviolet emitters (such as, for example, light emitting diodes based on silicon carbide, aluminium gallium nitride or aluminium nitride), visible emitters (such as, for example, light emitting diodes based on gallium phosphide, aluminium gallium arsenide, gallium arsenide phosphide or indium gallium nitride, incandescent tungsten filament lamps, electro-luminescent sheet devices, polymer light emitting diodes or gas discharge lamps), near infrared emitters (such as, for example, light emitting diodes based on gallium arsenide and gallium aluminium arsenide) and/or thermal emitters (such as, for example, heated surfaces—e.g. joule heated elements comprising a high thermal infrared emissivity surface—and light emitting diodes based on aluminium indium antimonide emitting in the 3,000 nm to 5,000 nm waveband). The afore-mentioned electro-optic emitters are by way of example only and do not comprise an exhaustive list. Many other suitable emitting devices will occur to the skilled person.

By selecting a particular type of electro-optic emitter, or a combination of different electro-optic emitters, an identification device can be provided which is visible to the human eye and/or one or more types of imaging device.

It is known to position an electro-optic identification device comprising near infrared and/or thermal infrared emitters on an object, the device itself typically having a shape that provides the desired angular coverage for the infrared emitters. However, a device of this type generally changes the profile of the object which it is marking. This can be disadvantageous in some scenarios, such as on the battlefield. In the present invention, the identification device instead comprises a support structure for a plurality of electro-optic emitters—preferably including one or more near infrared and/or thermal infrared emitters—which conforms, in use, to the shape of the object to be identified. As a result, the identification device can fit over all or part of the object, thereby ensuring that the profile of the object is substantially unchanged. In other words, in use the device does not appear as a discrete unit on the object, but instead fits to the shape of the object.

Advantageously, an object is chosen which has a shape capable of providing the desired angular coverage for the emitters. Preferably, the object has a regular or irregular domed shape, possibly a hemispherical or near-hemispherical shape. In one preferred embodiment of the invention, the object is a helmet and, in use, the support structure conforms to the shape of the helmet.

The support structure can take the form of a hollow rigid or semi-rigid shell in the shape of the object, in which case the support structure inherently conforms, in use, to the shape of the object. Alternatively, the support structure is capable of adapting its shape to the shape of the object and, in use, the identification device can be draped over the object such that its shape conforms thereto.

In either case, the identification device fits over the object during use. The device can additionally comprise fixing aids such as, for example, straps, hooks and clips, so as to secure the device in place. In contrast to the prior art, the invention does not necessarily rely on its own shape to provide the required angular coverage for the emitters, but instead uses a shape determined by the shape of the object—or part of an object—to be identified.

One advantage of the invention is that it can be placed over an existing feature on a vehicle, structure or person such that the profile of the feature is not altered. This is particularly important for a helmet mounted identification device, because the device can be used without increasing the so-called clearance volume and (in battlefield scenarios) without providing an increased target area. Moreover, the distance between the top of the neck and the centre of mass of the device is minimised by mounting the device over the helmet and consequently, torque and inertia on the neck are also minimised.

Yet another advantage of the invention over the prior art is that, because the emitters are positioned around an object in use rather than in a single position on top of an object, the emission can be distributed over a larger area. As a result, it is less likely that all or most of the emitters on the identification device are obscured during use.

Further advantages include secure attachment of the identification to the object in use and—due to the large surface area of the identification device—efficient heat dissipation from the electro-optic emitters. The latter advantage is particularly important for an identification device comprising emitters with a high waste heat dissipation, for example high intensity black-body thermal infrared emitters. Optionally, heat exchangers can be incorporated into the device to improve waste heat dissipation. Examples include, but are not limited to, phase-change heat exchangers and direct solid-gas heat exchangers.

In order to ensure the highest probability of detection for the identification device at a particular waveband and for a particular sensor configuration, it is desirable to project sufficient energy in the direction from where the device is being observed. Generally, the detection direction is unknown, however, so the identification device preferably projects sufficient power in all probable directions and wavelengths, and at an intensity sufficient to provide the required detection range. This is referred to as the emission intensity profile. In practice, sufficient energy is preferably projected over a hemisphere centred on the identification device, with the apex of the hemisphere directly above the device.

In some applications, the detection direction might already be known and accordingly, the distribution of emitted electro-optic energy may be configured to be non-uniform. In such an application, only certain emitters or groups of emitters may be illuminated so as to project energy only in the detection direction. In order that the identification device can determine in which direction it is currently orientated (so as to activate the appropriate emitters) the device can additionally be provided with ancillary components such as a GPS and/or an electronic compass. Advantageously, the emitters will be obscured from other vantage points by the bulk of the object, particularly in the case of a helmet mounted device.

An electro-optic emitter has an emission lobe characteristic which depends on the type and design of the emitter. In general, the emission lobes of the plurality of electro-optic emitters in the identification device, in combination with the required emission intensity profile for a particular application, tends to govern the number and positioning of the emitters in the device. For an adaptable support structure comprising a plurality of emitter arms radiating from a hub (described in more detail below), the number and positioning of the emitters are also dependant on the number and positioning of the emitter arms.

A rigid or semi-rigid support structure can be made from any suitable material, including composites, polymers, fabrics or webbing tape, and combinations of fabrics and polymers. Polymers may be natural or synthetic and examples of suitable polymers include, but are not limited to, vulcanised rubbers, nitrile rubbers, silicone rubbers, polyolefins, vinyl polymers, nylons and polyurethanes. Thermosetting resins can also be used, and are particularly useful for the production of small numbers of devices. Examples of possible thermoset materials include, but are not limited to, epoxies, phenolic resins, polyesters and polyurethanes.

In a preferred embodiment, a rigid or semi-rigid support structure suitable for a helmet mounted identification device takes the form of a cap designed to fit over a helmet. The cap may have gaps, indents and openings so that the support structure fits around any parts that protrude from the helmet. The cap may have a faceted surface profile rather than a smoothly curved surface profile.

Although an identification device comprising a rigid or semi-rigid support structure might sometimes be advantageous, it can generally be used to identify an object having only one particular shape. (In other words, its application tends to be restricted to a particular object.) An identification device comprising an adaptable support structure, on the other hand, can fit over (and hence identify) objects having a wider range of different shapes. Accordingly, an adaptable support structure is generally preferred over a rigid or semi-rigid support structure.

One example of a support structure capable of adapting its shape to the shape of the object is a net or mesh, optionally a net or mesh whose shape can be adjusted using adjusting means. Suitable adjusting means include, but are not limited to, elastics, hooks, clips, tapes, buckles, press studs, toggles, buttons, draw strings and/or hook and loop fasteners.

Alternatively, the support structure can simply be a band of flexible material, which can be wound around the object—preferably the sides, perimeter or circumference of the object, depending on the object's shape—and fastened in place by suitable means, such as those listed above in relation to a net or mesh support structure.

More preferably, however, the adaptable support structure takes the form of a plurality of emitter arms—preferably flexible emitter arms—radiating from a hub, each arm comprising one or more electro-optic emitters. An identification device comprising a support structure of this type can have a planar or near planar configuration when not in use (thereby simplifying manufacture and logistical aspects such as storage) but can easily be positioned over an object requiring identification, the hub and emitter arms conforming to the shape of the object. Suitably, the hub is positioned at the top or apex of the object during use, and the emitter arms are draped down the sides of the object at different positions around the object. One or more of the plurality of electro-optic emitters can also be positioned on the hub to assist with projecting the required emission intensity profile.

The number of emitter arms depends on the particular application, the required angular coverage of the emitters, the wavelength of the emitters and the required emission intensity profile. The number of emitter arms also depends, however, on practical considerations such as the size of the object, the size and shape of the emitter arms themselves and the size and position of any parts of the object that cannot be covered, or that would obscure the emitters (such as, for example, the NVG bracket on a military helmet). For a helmet mounted device, 3 or more emitter arms are desirable. More preferably, the number of emitter arms lies in the range 3 to 10, even more preferably in the range 4 to 9 and yet more preferably in the range 5 to 8. In addition to the plurality of emitter arms, the support structure may comprise one or more arms having no electro-optic emitters. These additional arms may comprise components such as switches, power connections, device electronics, Bluetooth® communication chips, GPS location devices, electronic compass chips, fixing means and/or a power supply unit. All or some of the arms may have a region to which temporary marking materials can be applied such as, for example, filtered or un-filtered electro-optic retro-reflective materials and identification symbols.

The plurality of emitter arms can be spaced equally around the hub so that they have a substantially uniform radial spread or, alternatively, can be spaced at different (non-uniform) intervals. In operation, all of the arms may be switched on together or, alternatively, in a programmed sequence. By switching individual arms on at different times, the angular emission profile can be varied. Similarly, the emissions from individual electro-optic emitters may be programmed to occur either simultaneously or non-simultaneously. Preferably, the emissions occur non-simultaneously so as to reduce instantaneous peak power requirements.

By hub is meant a central region of the identification device from which the plurality of emitter arms radiate. The hub may be a separate component attached to the emitter arms, or, alternatively, can simply be the point of intersection of two or more emitter arms. The hub can take any suitable form such as, for example, a plate or cap, a ring or loop, or a mesh. The hub can be any suitable shape, but—especially for a helmet mounted device—the hub is preferably circular, oval or a circular or oval toroid.

The plurality of emitter arms and hub can be formed either from the same material or from different materials. Preferably, the hub and emitter arms are formed from the same material, and more preferably the hub and emitter arms together comprise an integral support structure formed from the same material. Forming the arms and hub from the same material can simplify manufacture and, in one preferred embodiment, the support structure is simply cut out or moulded from a suitable material. If the hub and emitter arms are formed from different components and/or materials, they may be connected together to form the support structure by any suitable mechanical attachment and/or electrical connection means such as, for example, clips, buckles, hinges, and plugs and sockets.

The emitter arms can be any size or shape and, moreover, each emitter arm can be a different size and/or shape. Preferably, however, the emitter arms have a larger longitudinal dimension (length) than lateral dimension (width), and more preferably the arms take the form of straps having uniform or non-uniform width. In one particularly preferred embodiment of the invention, the emitter arms take the form of straps which are wider towards the mid-point of the length. This provides a larger area for mounting the plurality of electro-optic emitters and enables groups of emitters to be positioned in a variety of different configurations or patterns. Conveniently, although not necessarily, the arms do not overlap with each other when the identification device is used.

The adaptable support structure can comprise a flexible material so that it readily conforms to the shape of the object during use. The flexible material may be a flexible polymer—preferably an elastomer—or a woven or elasticated material, or a combination thereof. Suitable flexible polymers (which may be natural or synthetic) include vulcanised rubbers, silicone rubbers, nitrile rubber, polyolefins—such as, for example, ethyl propyl diene monomers—vinyl polymers, nylons and polyurethanes.

To control the drape and fit of the device to the object, prevent strain on electrical components, connections and connective circuitry and to assist with storage, sections of the plurality of emitter arms can be reinforced with non-extensible inclusions such as non-extensible polymers, fabrics or wires. Other sections may be narrower and/or thinner to create a section that preferably bends or folds.

Whichever type of support structure is used (that is, a rigid or semi-rigid hollow structure, or an adaptable structure) the precise positioning of the emitters on the support structure depends on the intended application for the device and (as discussed above) the required intensity profile. Generally, however, the emitters are arranged such that, in use, the identification device provides the required emission intensity profile required to enable detection from the ground and/or air and, typically, from two or more different directions at one time.

The plurality of electro-optic emitters can be mounted onto the support structure in any suitable manner. For example, the emitters can be fixed onto the surface of the support structure, or wholly or partially embedded within the structure. Preferably, the emitters are mounted such that protrusion above the surface of the support structure is minimised whilst still providing the desired emission characteristics. In other words, it is desirable to embed the plurality of emitters in the support structure in a manner which reduces the physical profile of the identification device, but avoids obscuration effects that could restrict the emission characteristics of the emitters. The inventors have found that, in general, the more exposed the front of the emitter is, the greater the angular coverage that can be obtained. However, there is also an increased risk that the emitters can be damaged in use. One preferred solution to this problem is to provide a protective ring which protrudes from the support structure around an emitter, the ring being positioned at a distance from the emitter edge which provides physical protection without comprising emission by obscuring the emitter line of sight. The optimum distance of the ring from the emitter edge depends on the size of the emitter, but is typically greater than 0.5 mm and preferably between 1 mm and 3 mm. The ring can be formed from any suitable material, but is preferably formed from the same material as the support structure. If desired, a protective screen (such as, for example, a stiff wire cross or cage) can be provided over the emitter, to prevent the emitter window (if present) from being damaged through impact and suchlike. The screen can be provided as an alternative to, or in addition to, the protective ring.

One preferred way of mounting the emitters onto the support structure is to provide recesses or holes in the support structure for the emitters. The emitters can then simply be pushed into the recesses or holes. It has already been explained that the emitters are positioned so as to provide the required angular coverage for the identification device in use. It follows, therefore, that holes or recesses for the emitters are also preferably placed at appropriate locations to provide the required intensity profile.

Clearly, electrical connectors to the recesses or holes through the support structure are desirable. Channels can be provided in the support structure for wires and/or other electrical connectors. Conveniently, wires and/or other electrical connectors can also be incorporated into straps and suchlike used to secure the identification device in place. One example of a fastener suitable for incorporating wires is a webbing fastener, preferably a webbing strap, which can comprise wires woven into the mesh.

The emitters are generally all positioned on the same (outer) surface of the support structure so that, when the identification device conforms to the shape of the object in use, all of the emitters are outwardly facing.

The support structure can be made by any suitable technique. A rigid or semi-rigid structure is typically made by a method selected from injection moulding, lost wax casting, compression moulding, stereo lithography, pre-impregnated composite lay up and wet resin lay up. Other alternative methods will occur to the skilled person. An adaptable support structure can be made by a method selected from techniques including injection moulding, casting and cutting from a sheet. Again, alternative methods will occur to the skilled person.

The plurality of electro-optic emitters can be selected such that the identification device emits radiation at any desired wavelength, but preferably emitters are chosen that operate in the ultra violet, visible, near infrared and thermal infrared wavebands. Desirably, wavelength ranges coincide with the atmospheric transmission windows and sensitivity ranges of electro-optic sensors. The identification device can operate as a multi-spectral device, whereby the plurality of electro-optic emitters includes at least two emitters operating in different wavebands or at specific wavelength ranges, or—alternatively—as a mono-spectral device, whereby the plurality of emitters emit radiation in the same waveband or at a specific wavelength range.

For a multi-spectral device, any combination of wavebands or wavelength ranges can be used. A preferred waveband combination, however, includes near infrared and thermal infrared wavebands, more preferably near infrared, medium wave thermal infrared and/or long wave thermal infrared, and most preferably the plurality of electro-optic emitters operate in the specific wavelength intervals 800 nm to 900 nm, 3,000 nm to 5,000 nm and/or 8,000 nm to 12,000 nm. Examples of 800 nm to 900 nm emitters that can be used in the invention are OD050 and OD633 devices supplied by Opto Diode Corp. (750 Mitchell Road, Newbury Park, Calif. 91320 USA). Examples of 8,000 nm to 12,000 nm emitters that can be used in the invention are custom filtered versions of IR40 and IR50 devices supplied by Scitec Instruments Ltd (Bartles Industrial Estate, North Street, Redruth, Cornwall TR15 1HR, UK) or ReflectIR-P1N NL8LNC or MarkIR 812 devices supplied by ICx Photonics Inc. (4 Federal Street, Billerica, Mass. 01821, USA). Examples of 3,000 nm to 5,000 nm emitters that can be used in the invention include direct band gap AlₓIn₁₋ₓSb LED emitters grown by molecular beam epitaxy (available from QinetiQ Limited, Malvern Technology Centre, St Andrews Road, Malvern, Worcestershire WR14 3PS, UK) or MarkIR 35 devices supplied by ICx Photonics Inc. (4 Federal Street, Billerica, Mass. 01821, USA).

For a multi-spectral device comprising an adaptable support structure having a hub and plurality of emitter arms, the emitters may be distributed among the emitter arms in any pattern that provides the required emission intensity profile. For a multi-spectral device, it is preferable that each emitter arm comprises at least one emitter of each waveband. Additionally, to meet the emission intensity profile, the hub may also be populated with at least one emitter of each waveband or wavelength range.

The emitters can be programmed to have an on/off output (i.e. a flash output), but preferably the emitters have a pulse output intensity with a rise and fall time. This provides the advantage that, on the battlefield, the output from the emitters can be distinguished from muzzle flash. This feature is particularly desirable for identification devices comprising thermal emitters.

Power can be supplied to the emitters either by incorporating a power supply into the device itself, or by connecting the device to a remote power supply unit in the object or elsewhere. One convenient way of connecting the device to a remote power supply is via a cable, conveniently a coiled cable with an optional woven sleeve. Other means will suggest themselves to the skilled person. The power supply can be any suitable power supply, but is preferably a man- or vehicle-portable supply such as, for example, a primary electrochemical cell, an accumulator including a secondary or re-chargeable electrochemical cell, a fuel cell, a photovoltaic cell or array of photovoltaic cells, a super capacitor, a generator or a dynamo, or any combination thereof.

In a preferred embodiment, the identification device comprises a control and/or power supply module which can be mounted onto the object. The module is typically coupled to the support structure so that control and/or power signals can be transmitted between the support structure and module, and is preferably closely coupled with the support structure so as to form an integral device. For a helmet mounted device, the control and/or power supply module is preferably positioned on the device so that, in use, it lies near the base of the helmet. If the helmet comprises an NVG bracket (i.e. may be used with NVGs), the module is preferably positioned near the base of the helmet substantially opposite the NVG bracket. This provides the advantage that, in use, the module counter-balances the night vision goggles.

The control and/or power supply module can comprise a toggle switch or suchlike, so that the user can switch between different emission modes. For example, the switch may allow the user to select near IR emission, thermal IR emission or near IR and thermal IR emission.

The identification device may be configured for use with remote ‘wake up’ control signals and accordingly, comprise a wake up control module. In ‘wake up’ mode the identification device would remain dormant until activated by a control signal. This provide the advantage that the device can remain covert until required and/or that power can be conserved until required.

According to a second aspect of the invention, there is provided a helmet comprising an identification device as described above in relation to the first aspect.

According to a third aspect of the invention, there is provided a helmet mounted infrared beacon comprising a support structure having a plurality of infrared emitters positioned thereon, wherein the support structure is capable of adapting its shape to the shape of the helmet. Preferably, the support structure takes the form of a plurality of emitter arms radiating from a hub, each arm comprising one or more infrared emitters.

In a preferred embodiment, the helmet mounted device is a multi-spectral device wherein the plurality of electro-optic emitters includes a combination of near infrared and thermal infrared emitters, the near infrared emitters preferably operating in the 830 nm to 930 nm wavelength range, and the thermal infrared emitters preferably operating in the 3,000 nm to 5,000 nm and/or 8,000 nm to 12,000 nm wavelength ranges. The identification device may additionally comprise one or more emitters operating in the visible waveband. Preferably, the combination of near infrared and thermal infrared emitters—and, if present, the optional visible emitters—are arranged to emit radiation in two or more different directions, so as to provide a multi-directional device.

According to a fourth aspect of the invention, there is provided a method of identifying an object, said method comprising the step of positioning on said object an identification device comprising a support structure having a plurality of electro-optic emitters positioned thereon, wherein the support structure conforms, in use, to the shape of the object. By conforming to the shape of the object, the device can provide the required emission intensity profile.

Any feature in one aspect of the invention may be applied to any other aspects of the invention, in any appropriate combination. In particular device aspects may be applied to method aspects and vice versa. The invention extends to a device and method substantially as herein described, with reference to the accompanying drawings.

### DESCRIPTION OF THE DRAWINGS

The invention will now be described, purely by way of example, with reference to the accompanying drawings, in which;

FIG. 1 is a schematic representation of an identification device according to a first embodiment of the invention in use;

FIG. 2 is a schematic, top-down representation of an identification device according to a second embodiment of the invention;

FIG. 3 is a schematic, sideways elevational view of the identification device of FIG. 2 in use;

FIG. 4 is a schematic, front view of the identification device of FIG. 2 in use;

FIGS. 5a to 5c are cross-sectional views of an electro-optic emitter mounted in the support structure, and FIG. 5d is a top-down view of FIG. 5c;

FIG. 6 is an elevational view of an identification device according to a preferred aspect of the invention mounted on a helmet; and

FIG. 7 is an 8-12 micron thermal image of a helmet mounted identification device.

### DETAILED DESCRIPTION OF THE INVENTION

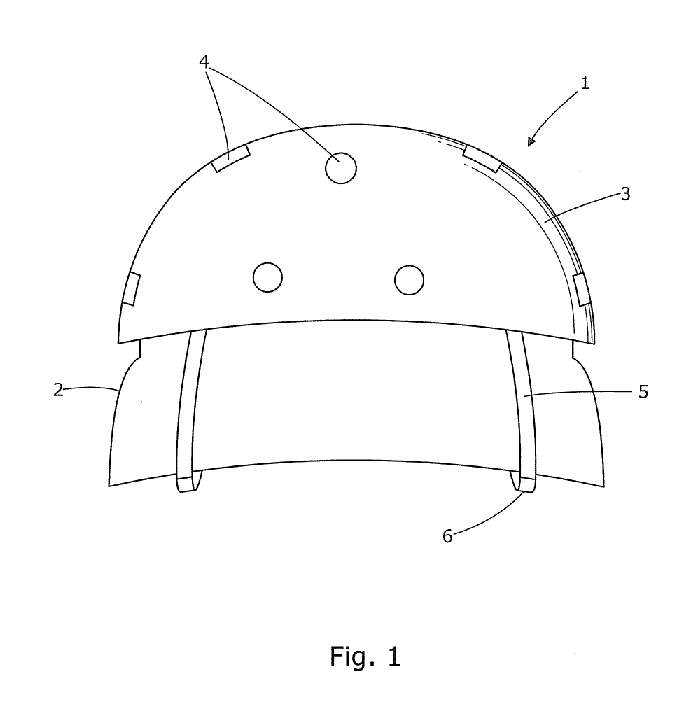

FIG. 1 is a schematic representation of an identification device according to a first embodiment of the invention in use. Identification device 1 is suitable for use with a helmet 2 and comprises a rigid support structure 3 taking the form of a hollow shell. The shell has substantially the same shape as the top part of helmet 2, and a slightly larger size so as to fit over the helmet. Thus, in use, device 1 conforms to the shape of helmet 2. The support structure 3 comprises a plurality of electro-optic emitters 4 positioned thereon and fixing straps 5. The fixing straps comprise clip fasteners 6 (conveniently metal clip fasteners made, for example, from stainless steel) which are fixed under the rim of helmet 2 to secure the device in place.

The plurality of electro-optic emitters include near infrared emitters in the 800 nm to 900 nm wavelength range, and thermal emitters in the 3,000 nm to 5,000 nm and 8,000 nm to 12,000 nm wavelength ranges. The plurality of emitters are positioned around the device so as to provide a multi-spectral signature from different observation angles.

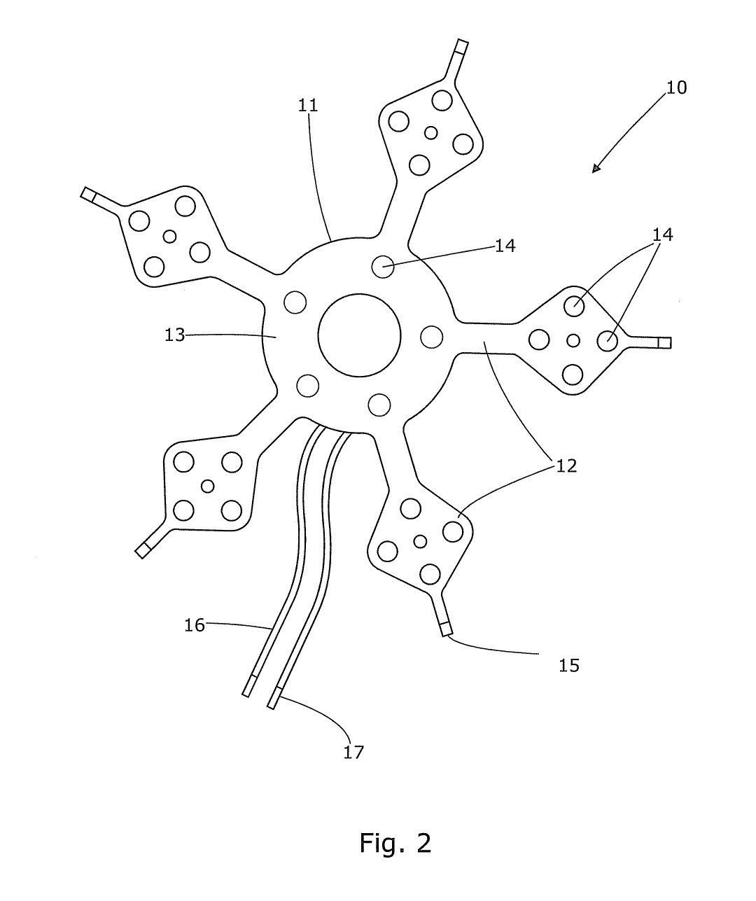

FIG. 2 is a schematic, top-down representation of an alternative identification device according to the invention. Identification device 10 is suitable for mounting on a hemispherical shaped object, preferably a helmet, and comprises a support structure 11 capable of adapting its shape to the shape of the object. Specifically, the device 10 comprises five emitter arms 12 radiating from hub 13. Each emitter arm comprises five electro-optic emitters 14, the five emitters being a combination of visible, near infrared and thermal infrared emitters operating in the 3,000 nm to 5,000 nm and/or 8,000 nm to 12,000 nm wavelength ranges. Electro-optic emitters 14 are also provided on hub 13. The hub emitters also comprise a combination of visible, near infrared and thermal infrared emitters. Clips 15 are provided at the end of each emitter arm 12 to secure the device to a helmet (or other dome or near-dome shaped object) in use.

Support structure 11 is an integral structure formed from a flexible material (in other words, emitter arms 12 and hub 13 are both formed from the same flexible material). Suitable flexible materials are elastomers such as nitrile rubber or silicone rubber. The electro-optic emitters 14 are embedded in recesses in the support structure and connected to a network of wires embedded in the support structure (not visible). Electrical leads 16 and connectors 17 provide an electrical connection to an external power supply in use. Optionally, protective rings can be provided around emitters 14.

The device of FIG. 2 is shown in its open, un-mounted form. The device is substantially planar with a radial dimension of about 400 mm and a thickness of about 5 mm.

The emitter arms of identification device 10 are shaped such that the electro-optic emitters are positioned in a cluster. This provides the advantage that the emission intensity profile is maximised for the most likely observation angle. However, the emitter arms may take other shapes such as, for example, a strap of uniform width having electro-optic emitters positioned in a line along its length. If required, the emitter arms may each have different shapes.

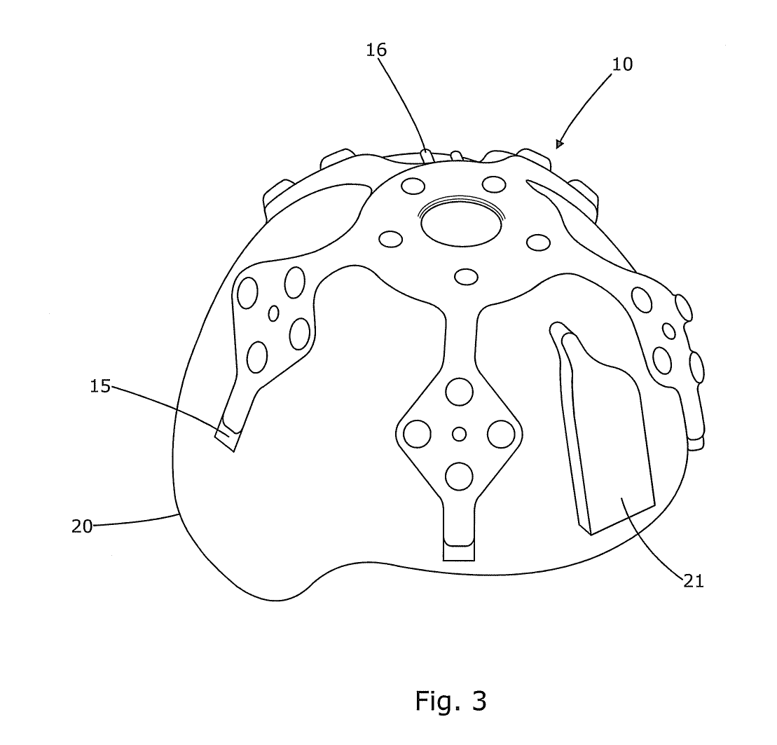

FIG. 3 is a schematic, sideways elevational view of identification device 10 mounted on a helmet 20. Helmet 20 comprises an NVG bracket 21 and, in use, the emitter arms conveniently drape around the helmet so as to avoid obscuring the bracket and to prevent the NVG, once mounted, from obscuring the electro-optic emission from the device. The device is secured in place by clips 15, which can be fastened to standard military helmet webbing (not shown) worn underneath the device or clipped under the rim of the helmet. Electrical leads 16 are attached to a battery back fixed to the rear of the helmet (not visible).

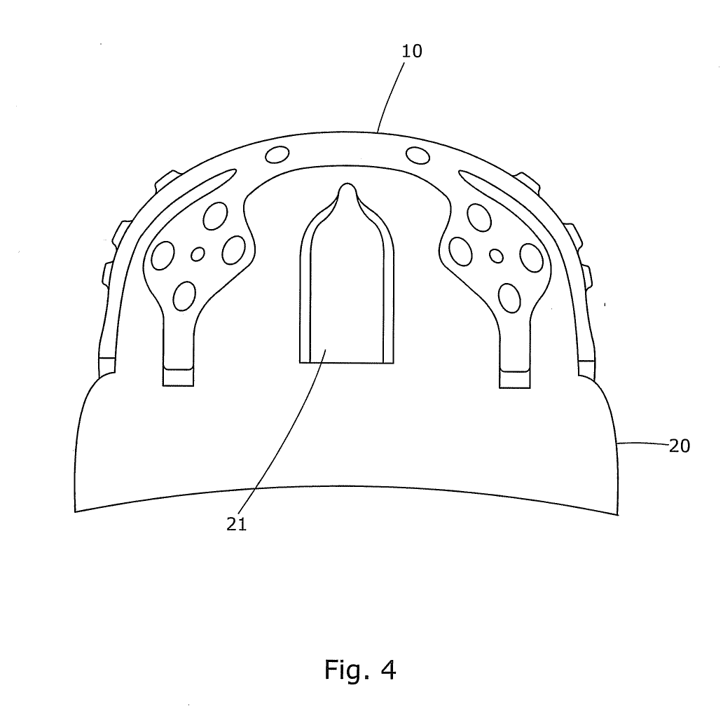

FIG. 4 is a schematic, front view of identification device 10. Again, the Figure shows that the device can be mounted to avoid obscuring NVG bracket 21 and to prevent the NVG, once mounted, from obscuring the electro-optic emission from the device. It can also be seen that, once mounted, the device conforms to the shape of helmet 20 and exhibits a low profile.

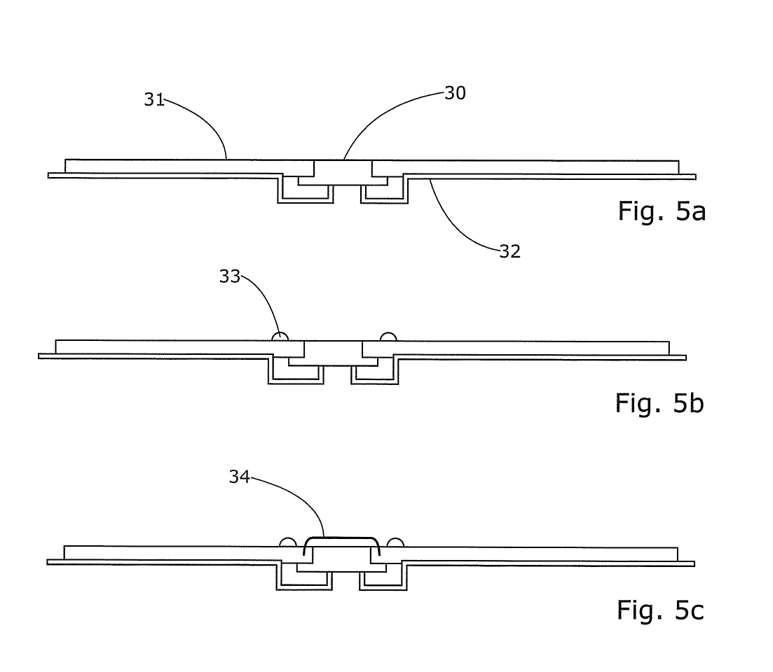

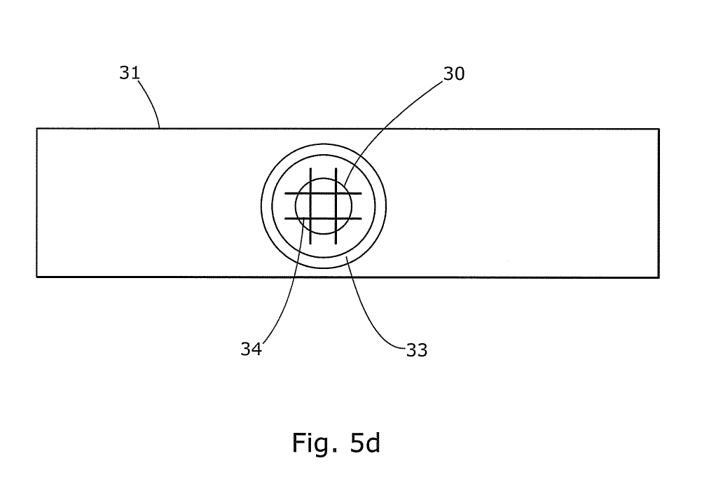

FIGS. 5a to 5c are cross sectional figures illustrating various ways of mounting an electro-optic emitter 30 in a section of the support structure 31. In FIG. 5a, the electro-optic emitter 30 is wholly embedded in the support structure 31 such that the surface of the emitter is flush with the outer surface of the support structure. Electrical connectors 32 run underneath the support structure, but may alternatively be embedded in the support structure or woven therethrough. An emitter mounted in this way provides good angular emission coverage, but is prone to damage. FIG. 5b shows the same flush-mounted emitter in a support structure having a protective ring 33. The protective ring is positioned around the emitter, at a distance from the emitter edge which provides physical protection without comprising emission by obscuring the emitter line of sight. FIG. 5c is a more preferred embodiment of FIG. 5b, in which a screen 34 (preferably a metal wire cage) is provided for additional protection.

FIG. 5d is a top-down view of the section of support structure shown in FIG. 5c showing emitter 30, support structure 31, protective ring 33 and protective screen 34. In an alternative embodiment, the emitter may protrude slightly from the surface of the support structure and be protected by the ring and/or screen.

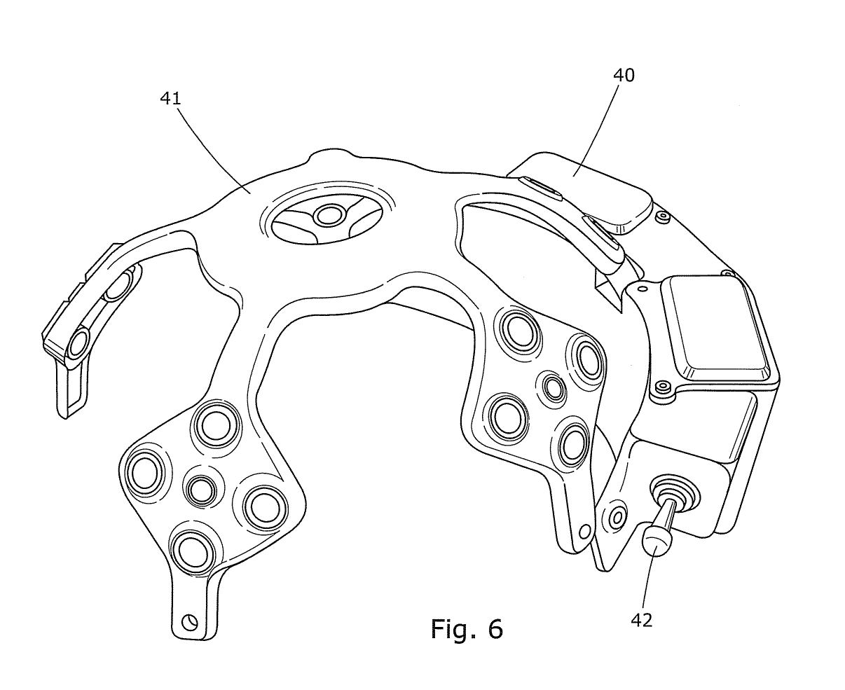

FIG. 6 is an elevational view of an identification device 41 suitable for mounting on a helmet, the device comprising an integral control and/or power supply module 40. In use, the identification device is preferably positioned such that the control and/or power supply module 40 lies at the rear of the helmet. In that position, the module can counter balances the weight of night vision goggles. Switch 42 can be used to turn the identification device off or on.

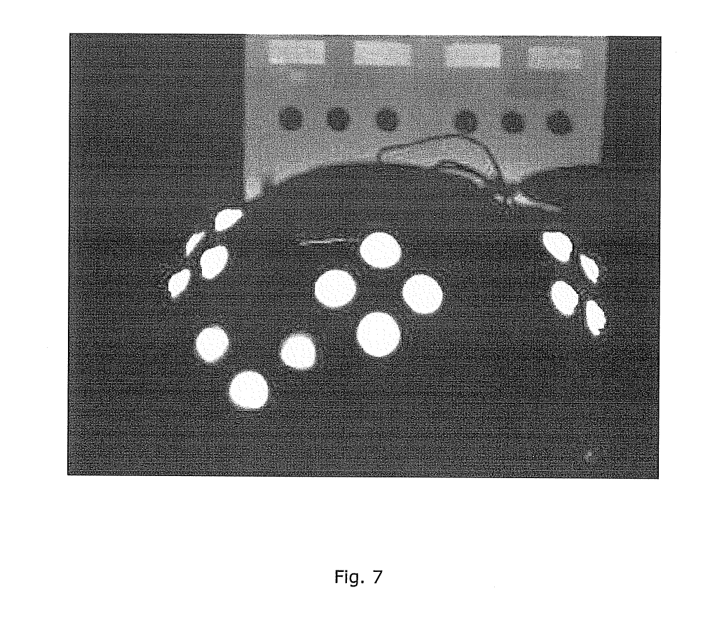

FIG. 7 is an 8-12 micron thermal image of a helmet mounted identification device according to the invention.

It will be understood that the present invention has been described above purely by way of example, and modification of detail can be made within the scope of the invention. Each feature disclosed in the description, and (where appropriate) the claims and drawings may be provided independently or in any appropriate combination.

The invention has been described with specific reference to electro-optic identification devices for military applications, and more particularly with reference to near and/or thermal infrared identification devices. It will be understood that this is not intended to be limiting and the invention may be used more generally. Other possible applications might include search and rescue, road safety, industrial safety, convoy marking, group marking, simulation and/or training. Additional applications of the invention will occur to the skilled person.

1. An identification device suitable for mounting on an object comprising a support structure having a plurality of electro-optic emitters positioned thereon, wherein the support structure conforms, in use, to the shape of said object.

2. An identification device according to claim 1, wherein the plurality of electro-optic emitters include visible emitters and/or infrared emitters.

3. An identification device according to claim 2, wherein the infrared emitters are selected from the group consisting of near infrared emitters, medium wave thermal infrared emitters and long wave thermal infrared emitters, or any combination thereof.

4. An identification device according to claim 1, wherein the support structure takes the form of a hollow rigid or semi-rigid shell in the shape of the object.

5. An identification device according to claim 1, wherein the support structure is capable of adapting its shape to the shape of the object.

6. An identification device according to claim 5, wherein the support structure takes the form of a plurality of emitter arms radiating from a hub, each arm comprising one or more electro-optic emitters.

7. An identification device according to claim 6, wherein the number of emitter arms lies in the range 3 to 10.

8. An identification device according to claim 6, wherein the plurality of emitter arms and hub are formed from the same material and together comprise an integral support structure.

9. An identification device according to claim 5, wherein the support structure comprises a net or mesh.

10. An identification device according to claim 5, wherein the support structure comprises a flexible material.

11. An identification device according to claim 5, wherein the support structure comprises a polymer, preferably an elastomer.

12. An identification device according to claim 11, wherein the elastomer is selected from the group consisting of nitrile rubber, silicone rubber, ethyl propyl diene monomers and polyurethane.

13. An identification device according to claim 1, wherein the plurality of emitters are embedded within the support structure so as to provide a low surface profile.

14. An identification device according to claim 1, wherein the electro-optic emitters are arranged such that, in use, the device emits radiation in two or more directions.

15. An identification device according to claim 1, wherein the electro-optic emitters are selected and arranged to provide a required intensity profile.

16. An identification device according to claim 15, wherein, in use, sufficient energy is projected over a hemisphere centred on the identification device, with the apex of the hemisphere directly above the device.

17. An identification device according to claim 15, wherein the emitters are switched on at different times to vary the intensity profile.

18. An identification device according to claim 1, wherein the emissions from individual electro-emitters occur non-simultaneously.

19. An identification device according to claim 1, additionally comprising a power supply unit.

20. A helmet mounted identification device comprising a support structure having a plurality of infrared emitters positioned thereon, wherein the support structure is capable of adapting its shape to the shape of the helmet.

21. A helmet mounted identification device according to claim 20, wherein the support structure takes the form of a plurality of emitter arms radiating from a hub, each arm comprising one or more infrared emitters

22. A method of identifying an object, said method comprising the step of positioning on said object an identification device comprising a support structure having a plurality of electro-optic emitters positioned thereon, wherein the support structure conforms, in use, to the shape of the object.

23. An method according to claim 22, wherein the support structure is capable of adapting its shape to the shape of the object.

24. A method according to claim 23, wherein the support structure takes the form of a plurality of emitter arms radiating from a hub, each arm comprising one or more electro-optic emitters.
